(19) United States
(12) Patent Application Publication
(10) Pub. No.: US 2013/0170402 A1
(43) Pub. Date: Jul. 4, 2013

(54) System and Method of enhanced call control through SMS based protocol

(71) Applicant: Web3Tel Inc., Toronto (CA)

(72) Inventors: Konstantin Manyakin, Jr., Toronto (CA); Adiel Rozinov, Richmond Hill (CA)

(73) Assignee: WEB3TEL INC., Toronto (CA)

(21) Appl. No.: 13/705,079

(22) Filed: Dec. 4, 2012

Related U.S. Application Data
(60) Provisional application No. 61/569,218, filed on Dec. 10, 2011.

(51) Int. Cl. H04L 29/06

(52) U.S. Cl. CPC H04L 29/0638
USPC 370/259

(57) ABSTRACT

A method and system for enhanced call control through SMS based protocol employs a mobile handset optionally equipped with application client to send call control commands and additional information by short message service (SMS) to call control application server. Such commands will be processed by the application server based on information received through SMS and as a result the application server will provide different call control functionality such as but not limited to call establishment between different subscribers, 3d party call control features, different types of conference and transfer, adding or removal terminals from the controlled group, manipulation with specific calling group like simultaneous call (SIM) group or haunting group, association of controlled terminal with specific personal access numbers (DID) and others. All call control steps could be done seamlessly by mobile application from the prospective of the user of the mobile handset.

### CROSS-REFERENCE TO RELATED APPLICATIONS

This application claims the benefit of Applicants' prior provisional application, number [61/569,218], filed on [Dec. 10, 2011]

### MICROFICHE APPENDIX

Not Applicable.

### TECHNICAL FIELD OF INVENTION

This application relates in general to providing of enhanced call control and communications services and, in particular, to a method and system for enhanced call control through SMS based protocol for cellular calls in a Voice over Internet Protocol (VoIP) or an IP Multi-Media Subsystem (IMS) network.

### BACKGROUND OF THE INVENTION

In the context of VoIP service provider it is necessary to provide cost-effective and flexible solution for enabling enhanced call control features from customers mobile handsets. Such mechanisms should be simple and robust to the variety of network conditions in which subscriber's phones can operate.

Sending call control sequences through data network can be sensitive to the availability and quality of data connection. At the same time SMS service is much more reliable and robust to network operation conditions. Other known ways of call control through sending DTMF sequences in the context of connected calls are changing the user pattern of call establishing and manipulation and also adding additional delays.

There therefore exists a need for a method and system that provides reliable and effective way of enabling enhanced call control features which can be done in user friendly manner without additional post-dial delays and without special requirements to availability of data connection.

Even when user's mobile terminal is not equipped with mobile application simplified SMS based protocol can enable enhanced call control features.

There therefore exists a need for service providers to enable a method and system for enhanced call control through SMS based protocol.

### BRIEF SUMMARY OF THE INVENTION

It is therefore an object of the invention to provide a method and a system for enhanced call control through SMS based protocol for cellular call launched by subscriber or on behalf of subscriber.

The invention therefore provides a method for enhanced call control through SMS based protocol, comprising: composing SMS message manually or by mobile application embedded into the mobile handset; sending an SMS call control message (SMSCCM) containing the called number or numbers that should be controlled, location, authentication credentials and other information to the call control application server (CCAS) through certain SMSC number; receiving this SMSCCM by CCAS and processing it; authenticating the user who sent the message based on provided credentials, SMS origination number or other ways; initiating call control functionality such as but not limited to call establishment between different subscribers, 3d party call control features, different types of conference and transfer, adding or removal terminals from the controlled group, manipulation with specific calling group like simultaneous call (SIM) group or haunting group, association of controlled terminal with specific personal access numbers (DID) and others according to command received in SMSCCM.

The invention further provides a system for enhanced call control through SMS based protocol, comprising: a mobile handset optionally equipped with application client programmed to: monitor user input to a mobile handset to intercept selected cellular telephone calls launched using the mobile handset or any other actions related to controlling of existed connected calls; provide user interface for account related actions such as but not limited to adding or removal terminals from the controlled group, manipulation with specific calling group like simultaneous call (SIM) group or haunting group, association of controlled terminal with specific personal access numbers (DID) and others; provide user interface for advanced call control actions such as but not limited to 3d party call control features, different types of conference and transfer and others; monitor the location of the mobile handset; select SMSC number based on the location of the mobile handset; send an SMS call control message (SMSCCM) containing the called number or numbers that should be controlled, location, authentication credentials and other information to the call control application server (CCAS) through certain SMSC number; and launch or answer necessary telephone calls from the mobile cellular handset as result of these call control actions; and a call control application server (CCAS), comprising a service programmed to: receive this SMSCCM by CCAS and process it; authenticate the user who sent the message based on provided credentials, SMS origination number or other ways; initiate call control functionality such as but not limited to call establishment between different subscribers, 3d party call control features, different types of conference and transfer, adding or removal terminals from the controlled group, manipulation with specific calling group like simultaneous call (SIM) group or haunting group, association of controlled terminal with specific personal access numbers (DID) and others according to command received in SMSCCM on behalf of subscriber's account.

The invention further provides a mobile handset application client, comprising: program instructions for monitoring user input to a mobile handset to intercept selected cellular telephone calls launched using the mobile handset or any other actions related to controlling of existed connected calls; providing user interface for account related actions such as but not limited to adding or removal terminals from the controlled group, manipulation with specific calling group like simultaneous call (SIM) group or haunting group, association of controlled terminal with specific personal access numbers (DID) and others; providing user interface for advanced call control actions such as but not limited to 3d party call control features, different types of conference and transfer and others; monitor the location of the mobile handset; selecting SMSC number based on the location of the mobile handset; sending an SMS call control message (SMSCCM) containing the called number or numbers that should be controlled, location, authentication credentials and other information to the call control application server (CCAS) through certain SMSC number selected based on terminal location and preconfigured preferences; and launching or answering necessary telephone calls from the mobile cellular handset as result of these call control actions.

The invention yet further provides a call control application server, comprising: a service application that receives this SMSCCM by CCAS and processes it; extracts location information, subscriber identification and call control commands; authenticates the user who sent the message based on provided credentials, SMS origination number or other ways; initiates call control functionality such as but not limited to call establishment between different subscribers, 3d party call control features, different types of conference and transfer, adding or removal terminals from the controlled group, manipulation with specific calling group like simultaneous call (SIM) group or haunting group, association of controlled terminal with specific personal access numbers (DID) and others according to command received in SMSCCM on behalf of subscriber's account; optionally initiates SMS messages back to subscriber's phones; optionally transforms or normalizes phone numbers existed in call control sequence according to the subscriber specific rules and current subscriber's phone location.

### BRIEF DESCRIPTION OF THE DRAWINGS

The accompanying drawings incorporated in and forming a part of this specification illustrate several aspects of the invention, and together with the description serve to explain the principles of the invention.

FIG. 1 is a block representation of a communication environment according to one embodiment of the disclosure.

FIG. 2 provides an exemplary communication flow according to the embodiment of the disclosure where 3-way conference call has been established.

FIG. 3 is a block representation of a mobile handset with an application client according to one embodiment of the disclosure.

FIG. 4 is a block representation of a call control application server according to one embodiment of the disclosure.

### DETAILED DESCRIPTION OF THE PREFERRED EMBODIMENT

The embodiments set forth below represent the necessary information to enable those skilled in the art to practice the invention and illustrate the best mode of practicing the invention. Upon reading the following description in light of the accompanying drawings, those skilled in the art will understand the concepts of the invention and will recognize applications of these concepts not particularly addressed herein. It should be understood that these concepts and applications fall within the scope of the disclosure and the accompanying claims.

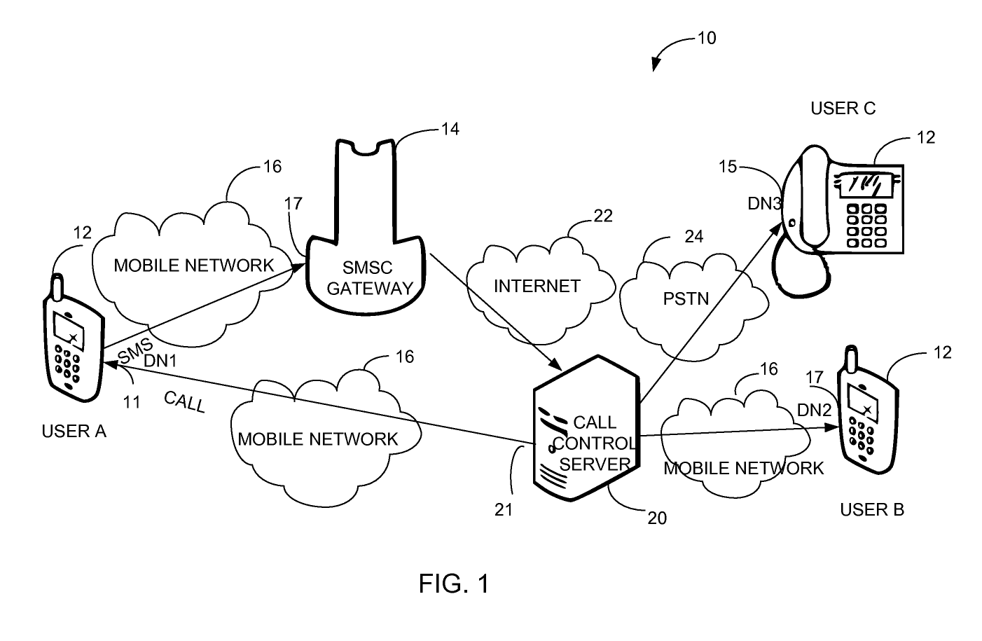

Prior to delving into the details of select embodiments, an overview of an exemplary communication environment 10 is provided in association with FIG. 1. In general, a call control application server (CCAS) 20 is provided to facilitate an example of 3d party call control functionality such as 3 ways conference initiated by getting call control SMS message through SMSC gateway 14. In an exemplary embodiment, the mobile handset 12 equipped with application client monitors user input to a mobile handset to intercept selected cellular telephone calls and send a call control SMS message (SMSCCM) with information about called number, other parties numbers, credentials and other information to SMS gateway 14 through certain SMSC number 17. The call control application server (CCAS) 20 will receive notification about SMS call control message, call control command with other parties numbers through correspondent communication; retrieve and verify the subscriber identification and credentials; optionally transforms or normalizes phone numbers existed in call control sequence according to the subscriber specific rules and current subscriber's phone location and formulate call setup requests to the called number and other parties numbers 15 and 17 (user B and C) through packet, mobile network 16 or circuit switched connections 24. After successful connections with all 3 parties the call control application server (CCAS) 20 will establish a 3 ways conference.

Notably, the devices 12 for user B and C may take virtually any form, including wired or wireless telephones, personal computers with VOIP application, and the like. The labels provided for these terminals in this description and the following claims are used only to improve readability and separately identify the terminals. Alternatively, the communication device 12 of user A should be a mobile handset (smartphone) with application client which support requested functionality and can communicate through mobile network 16 and send SMS messages.

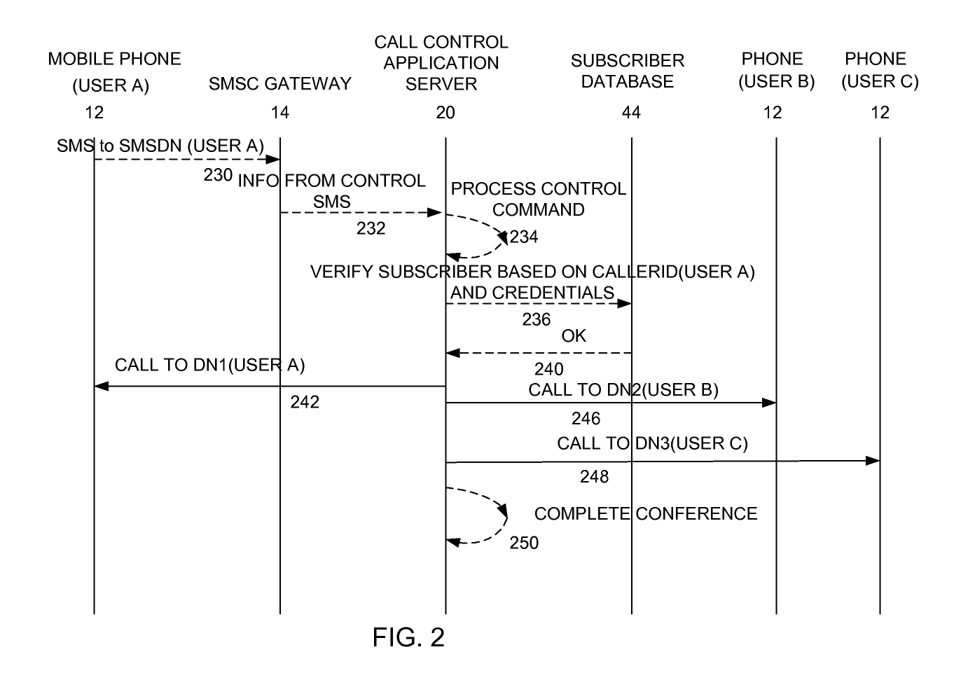

With reference to FIG. 2, a communication flow is provided to illustrate an exemplary scenario for utilizing the call control application server 20 to set up a 3 ways conference between user A with mobile handset 12 equipped with application client 30, user B and user C. This is only an exemplary scenario of 3d party call control functionality for three phones and the aspects and elements represented in the communication flow are not all deemed necessary for implementation of the present invention. For purposes of clarity, the mobile handset 12 of user A associated with DN A is labelled “Mobile Phone (user A) 12”. Likewise the mobile handset 12 of user B associated with DN B is labelled “Phone (user B) 12” and the phone 12 of user C associated with DN C is labelled “Phone (user C) 12”. The SMSC gateway 14 operates to receive call control SMS messages and provide call related information to the call control application server 20. In accordance with exemplary embodiments, the SMSC gateway 14 is separate from call control server 20 but maybe a part of it. The call control application server 20 operates to process call control SMS message received from the SMS gateway 14 and later provide necessary call control functionality. The subscriber database 44 operates to store user profile information, data from assisting SMS message and to provide this information to the service application 40 as requested. In exemplary embodiments, the user database 44 may form a part of the call control application server 20.

At some point, the user A decides to initiate a 3 way conference with the phones of user B and user C. Specifically, the application client 30 in phone (user A) 12 will send call control SMS (SMSCCM) containing the called number DN2 of user B and the called number of user C, location, credentials, call control command and other information to the call control application server (CCAS) 20 through certain SMSC DN number 17 (step 230) of SMSC gateway 14.

Next, the SMS gateway 14 receives call control SMS (SMSCCM) request message and extracts provided location information, subscriber identification, credentials, call control command, calling numbers and called number. This information will be sent to the call control application server (CCAS) 20 to its service application 40 through corresponding communication interface (step 232) where it will be processed and extracted (step 234). In exemplary scenario RESTful API 22 is used as such interface but it can be any type of inter services connectivity.

Now in possession of user A's DN, DN A (calling number), user A's location information and user B and C DNs (called numbers) the call control application server (CCAS) 20 stores this information in the subscriber database 44 (step 236). In exemplary scenario the call control application server (CCAS) 20 will provide subscriber identification and authentication based on caller ID of incoming call control SMS message (SMSCCM) but other information (for example, credentials in body of SMS message) can be used (step 240). After authentication the call control application server (CCAS) 20 could apply to the called numbers (DN1 of User B and DN2 of user C) corresponding dialing policies and phone number transformation rules.

Now in possession of user A's DN, user B's DN and user C's DN the call control application server (CCAS) 20 formulate a call setup request to the user A's number (step 242), user B's (step 246) and user C's (step 248).

After establishing the calls to these 3 phone numbers the call control application server (CCAS) 20 will formulate and complete the conference (step 250).

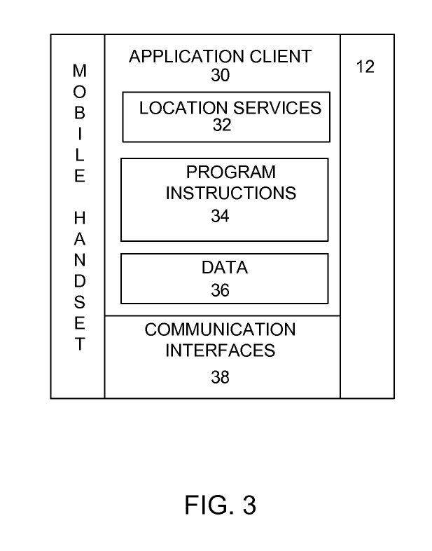

With reference to FIG. 3, a block representation of the mobile handset (smartphone) 12 with an application client 30 is illustrated according to one embodiment. The mobile handset 12 includes an application client 30 having capability of gathering location information from location services 32 and program instructions 34 and data 36 to operate as described above. The program instructions 34 provide the communication functions, data storage and gathering functions and geo location function which are described above. The application client 30 can interact with two communication interfaces 38 (SMS and call setup through mobile network) to provide call control functionality through SMS message as illustrated in the communication environment 10.

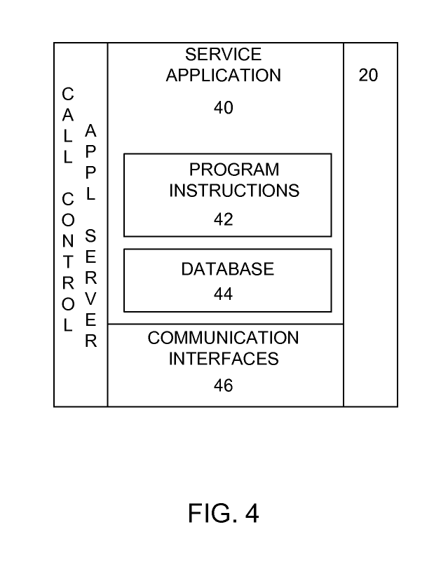

With reference to FIG. 4, a block representation of a call control application server 20 is illustrated. The call control application server 20 includes a service application 40 having capability to store and retrieve subscriber and call specific data in database 44 and program instructions 42 for processing call control SMS message, control call requests to destination DNs as described above. The service application 40 interacts with through several communication interfaces 48 with SMS gateways, PSTN and mobile network to provide call control functionality as described above.

Those skilled in the art will recognize improvements and modifications to the embodiments of the present invention. All such improvements and modifications are considered within the scope of the concepts disclosed herein and the claims that follow.

1. A method for enhanced call control through SMS based protocol, comprising: composing SMS message manually or by mobile application embedded into the mobile handset; sending an SMS call control message (SMSCCM) containing the called number or numbers that should be controlled, location, authentication credentials and other information to the call control application server (CCAS) through certain SMSC number; receiving this SMSCCM by CCAS and processing it; authenticating the user who sent the message based on provided credentials, SMS origination number or other ways; initiating call control functionality such as but not limited to call establishment between different subscribers, 3d party call control features, different types of conference and transfer, adding or removal terminals from the controlled group, manipulation with specific calling group like simultaneous call (SIM) group or haunting group, association of controlled terminal with specific personal access numbers (DID) and others according to command received in SMSCCM.

2. The method as claimed in claim 1 wherein composing SMS message manually or by mobile application embedded into the mobile handset further comprises including credentials information associated with the account of subscriber of call control service and an identification of the mobile subscriber.

3. The method as claimed in claim 2 wherein composing SMS message further comprises using subscriber's mobile phone number or his/her account id or some combination which can be optionally encrypted to identify the mobile subscriber.

4. The method as claimed in claim 1 further comprises collecting location information associated with a current location of the mobile handset and using this information for selecting local SMSC number by querying local database of SMSC numbers.

5. The method as claimed in claim 3 wherein sending the request message comprises formulating a SMSCCM request message containing but not limited to sequence of call control commands, one or many called or controlled numbers, the location information, an identification of the mobile subscriber and his/her credentials, other relevant information and sending the formulated SMSCCM request message over a SMS channel of the mobile network to selected SMSC number.

6. The method as claimed in claim 1 further comprising: receiving the SMSCCM request message at the CCAS; extracting call control commands, location information, subscriber identification, calling number and called and controlled numbers from the SMSCCM request message; authenticating this subscriber and executing corresponding call control commands.

7. The method as claimed in claim 6 wherein completing the call control command comprising: correlating SMSCCM message to calls that associated with given subscriber or with his account and executing: call establishment between different subscribers, 3d party call control features, different types of conference and transfer, adding or removal terminals from the controlled group, manipulation with specific calling group like simultaneous call (SIM) group or haunting group, association of controlled terminal with specific personal access numbers (DID) and others actions related to given subscriber's calls or on behalf of his account.

8. A system for enhanced call control through SMS based protocol, comprising: a mobile handset optionally equipped with application client programmed to: monitor user input to a mobile handset to intercept selected cellular telephone calls launched using the mobile handset or any other actions related to controlling of existed connected calls; provide user interface for account related actions such as but not limited to adding or removal terminals from the controlled group, manipulation with specific calling group like simultaneous call (SIM) group or haunting group, association of controlled terminal with specific personal access numbers (DID) and others; provide user interface for advanced call control actions such as but not limited to 3d party call control features, different types of conference and transfer and others; monitor the location of the mobile handset; select SMSC number based on the location of the mobile handset; send an SMS call control message (SMSCCM) containing the called number or numbers that should be controlled, location, authentication credentials and other information to the call control application server (CCAS) through certain SMSC number; and launch or answer necessary telephone calls from the mobile cellular handset as result of these call control actions; and a call control application server (CCAS), comprising a service programmed to: receive this SMSCCM by CCAS and process it; authenticate the user who sent the message based on provided credentials, SMS origination number or other ways; initiate call control functionality such as but not limited to call establishment between different subscribers, 3d party call control features, different types of conference and transfer, adding or removal terminals from the controlled group, manipulation with specific calling group like simultaneous call (SIM) group or haunting group, association of controlled terminal with specific personal access numbers (DID) and others according to command received in SMSCCM on behalf of subscriber's account.

9. A mobile handset application client, comprising: program instructions for monitoring user input to a mobile handset to intercept selected cellular telephone calls launched using the mobile handset or any other actions related to controlling of existed connected calls; providing user interface for account related actions such as but not limited to adding or removal terminals from the controlled group, manipulation with specific calling group like simultaneous call (SIM) group or haunting group, association of controlled terminal with specific personal access numbers (DID) and others; providing user interface for advanced call control actions such as but not limited to 3d party call control features, different types of conference and transfer and others; monitor the location of the mobile handset; selecting SMSC number based on the location of the mobile handset; sending an SMS call control message (SMSCCM) containing the called number or numbers that should be controlled, location, authentication credentials and other information to the call control application server (CCAS) through certain SMSC number; and launching or answering necessary telephone calls from the mobile cellular handset as result of these call control actions.

10. The application client as claimed in claim 9 further comprising a special identification records related to subscriber's account and optionally to device id used by the program instructions to provide proper credentials in SMSCCM.

11. The application client as claimed in claim 10 further comprising program instructions for selecting SMSC number based on location from the predefined list, which can be configured remotely.

12. A call control application server, comprising: a service application that receives this SMSCCM by CCAS and processes it; extracts location information, subscriber identification and call control commands; authenticates the user who sent the message based on provided credentials, SMS origination number or other ways; initiates call control functionality such as but not limited to call establishment between different subscribers, 3d party call control features, different types of conference and transfer, adding or removal terminals from the controlled group, manipulation with specific calling group like simultaneous call (SIM) group or haunting group, association of controlled terminal with specific personal access numbers (DID) and others according to command received in SMSCCM on behalf of subscriber's account.

13. The call control application server as claimed in claim 12 further comprising a service application that as a result of call control command processing can initiate different call setup request to connect the subscriber to proper numbers.

14. The call control application server as claimed in claim 12 further comprising a service application that as a result of call control command processing can initiate SMS messages back to subscriber's phones.

15. The call control application server as claimed in claim 12 further comprising a service application that can transform or normalize phone numbers existed in call control sequence according to the subscriber specific rules and current subscriber's phone location.
